(19) United States
(12) Patent Application Publication
(10) Pub. No.: US 2020/0282329 A1
(43) Pub. Date: Sep. 10, 2020

(54) Method for Extracting Effective Component from Plant by High-pressure Spraying Process

(71) Applicant: Wei Jiao, (US)

(72) Inventors: Wei Jiao, Rowland Heights, CA (US); Zhigang Shen, Xian (CN)

(21) Appl. No.: 16/811,551

(22) Filed: Mar. 6, 2020

Related U.S. Application Data
(60) Provisional application No. 62/815,117, filed on Mar. 7, 2019.

(51) Int. Cl. B01D 11/02; B01J 2/00

(52) U.S. Cl. CPC B01D 11/0288; B01D 11/028; B01J 2/00

(57) ABSTRACT

The method for extracting effective components from plant by high-pressure spraying process, comprising: pulverizing the plant to form raw plant material; atomized extracting the raw plant material to form crude extract; and concentrating the crude extract to form final extract. The step of atomized extracting the raw plant material to form crude extract comprises: soaking the raw plant material by soaking solution; high-pressure spraying the soaked raw plant material into an extraction solvent; and extracting the soaked raw plant material to form the crude extract.

### CROSS-REFERENCE TO RELATED APPLICATION

This application claims the priority of provisional patent application U.S. Ser. No. 62/815,117 filed Mar. 7, 2019 which is expressly incorporated by reference herein in its entirety.

### TECHNICAL FIELD OF THE INVENTION

The present application generally relates to extracting methods, and more particularly, to a method for extracting effective components from plant by high-pressure spraying process.

### BACKGROUND OF THE INVENTION

The plant extract is a product which is extracted from the plant. Specifically, the user may extract and concentrate the specific component(s) of the plant via physical and chemical separation process according to his/her demand without changing its active structure.

However, the main drawback of traditional extraction method is that the continuous extraction cannot be achieved since the extraction time is too long.

There are two modern extraction methods, supercritical extraction and microwave extraction. The supercritical extraction is a method utilizing supercritical fluid instead of conventional organic solvent for extraction and separation. The microwave extraction is a method utilizing the microwave-absorbing ability difference to selectively heat and extract the specific component(s) in the microwave field.

However, modern extraction methods have disadvantages such as large one-time investment and low utilization rate of extraction equipment. As such, modern extraction methods are not suitable for large production,

Therefore, a need remains for a method for extracting effective components from plant to provide a simple-operated, convenient and fast method for extraction.

### SUMMARY OF THE INVENTION

The present application discloses a method for extracting effective components from plant to provide a simple-operated, convenient and fast method for extraction.

The method for extracting effective components from plant by high-pressure spraying process, comprising: pulverizing the plant to form raw plant material; atomized extracting the raw plant material to form crude extract; and concentrating the crude extract to remove the extraction solvent to form final extract. The step of atomized extracting the raw plant material to form crude extract comprises: soaking the raw plant material by soaking solution; high-pressure spraying the soaked raw plant material into an extraction solvent; and extracting the soaked raw plant material to form the crude extract.

In various exemplary embodiments, the step of pulverizing the plant to form raw plant material comprises pulverizing the plant by pulverizer with a built-in 80-120 mesh screen sieve.

In various exemplary embodiments, the soaking solution is water or an ethanol solution with 30%-98% of volume concentration.

In, various exemplary embodiments, the step of soaking the raw plant material by ethanol solution further comprises soaking the raw plant material for 1-2 hours.

In various exemplary embodiments, the step of soaking the raw plant material by ethanol solution further comprises stirring. the raw plant material. A stirring rate for stirring the raw plant material is 60-100 r/min.

In various exemplary embodiments, after soaking the raw plant material by the ethanol solution, the method further comprises filtering the soaked raw material. Specifically, the soaked raw material is filtered by a 60 mesh screen sieve.

In various exemplary embodiments, a volumetric weight ratio between the soaking solution and the raw plant material is 6 L:1 kg.

In various exemplary embodiments, the step of atomized extracting the raw plant material to form crude extract further comprises pre-charging the extraction solvent into a tank before high-pressure spraying the soaked raw plant material into the extraction solvent. An extraction solvent, volume is ⅔-¾ of the tank. The extraction solvent is water or an ethanol solution. A nozzle is inserted 2-3 cm under a liquid surface of the extraction solvent for high-pressure spraying.

In addition, in various exemplary embodiments of the above embodiment, the step of atomized extracting the raw plant material to feint crude extract further comprises countercurrent spraying the extraction solvent from a bottom portion of the tank. A speed of countercurrent spraying the extraction solvent is 200-600 L/h. A speed of high-pressure spraying, the soaked raw plant material is 500-1000 L/h.

In Various exemplary embodiments, a pressure for high-pressure spraying the soaked raw plant material into the extraction solvent is 1.0-3.0 Mpa.

In various exemplary embodiments, the step of concentrating the crude extract to form final extract comprises: heating the crude extract to at least 60° C.; spraying the crude extract into a concentrator. wherein a vacuum degree inside the concentrator is −0.9 Mpa; and evaporating the extraction solvent of the crude extract to form the final extract.

Based on the above, the present application increases the contacting area between the solute and the solvent due to spraying technique. In addition, the solute diffusion is improved since the solvent is continuously countercurrent moving. Therefore, the rate of producing the final extract can be increased by 5-6 times. enhancing the extraction efficiency. Moreover, the solvent usage and consumption are greatly reduced, which in turn reduces the costs.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a view showing the extraction equipment and process.

FIGS. 2A-2B are flow charts of a method for extracting effective components from plant by high-pressure spraying process.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

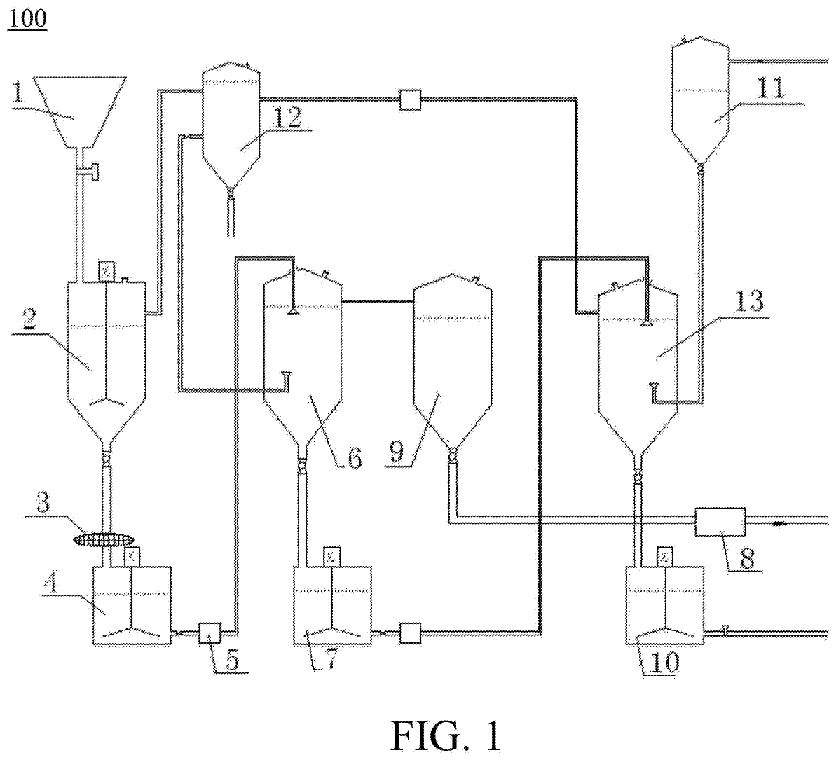

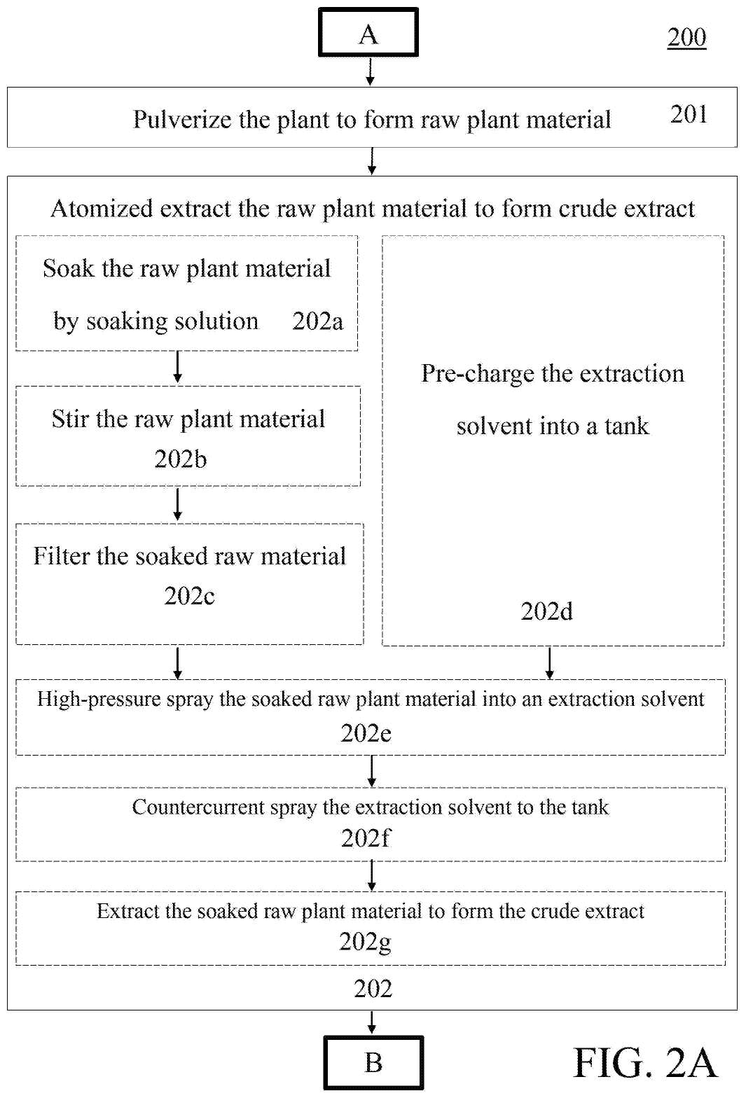

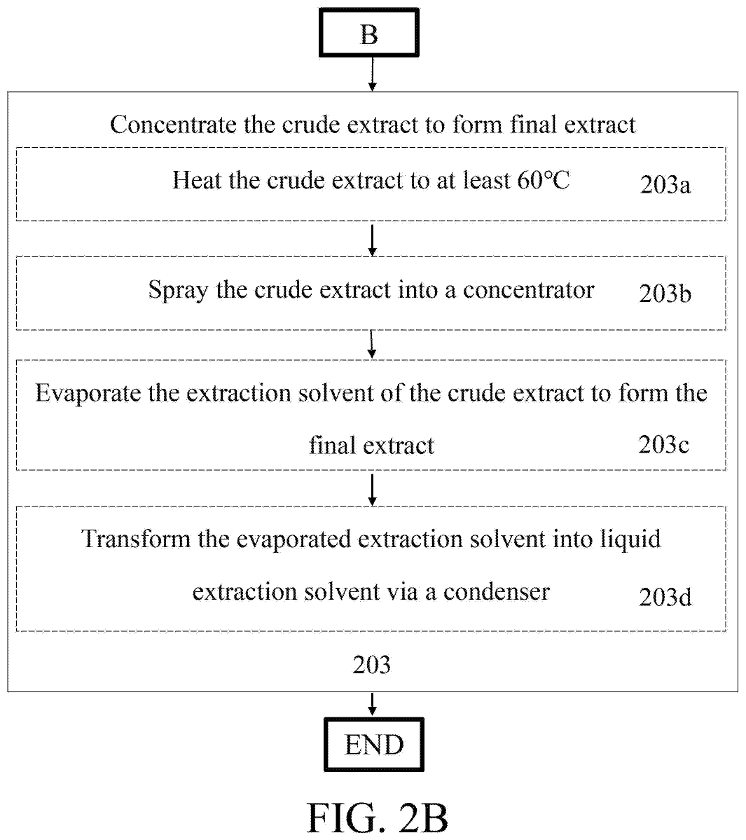

FIG. 1 is a view showing the extraction equipment 100 and process, FIGS. 2A-2B are flow charts of a method 200 for extracting effective components from plant by high-pressure spraying process.

Referring to FIGS. 1-2B, the extraction equipment 100 comprises plant container 1, a mixer 2, a sieve 3, a mixer 4, a high-pressure piston pump 5, am extraction tank 6, a mixer 7, a pump 8, an extract container 9, a residue container 10, a condenser 11, a solvent tank 12 and a concentrator 13.

As shown in step 201, a plant is pulverized inside the plant container 1 to form raw plant material. In detail, the plant is pulverized by a pulverizer with a built-in 80-120 mesh screen sieve.

Next, atomized extracting the raw plant material to form crude extract as shown in step 202. Specifically, the first step in the step 202 is soaking the raw plant material by soaking solution for 1-2 hours as shown in step 202a. The soaking solution in the present application can be water or an ethanol solution. If the soaking solution is the ethanol, a volume concentration of the ethanol solution is 30-98%. The volumetric weight ratio between the soaking solution and the raw plant material is 6 L:1 kg.

And then, stirring the raw as shown in step 202b. A stirring rate for stirring the raw material is 60-100 r/min. It should be noted that the step 202b can be done at the same time with the step 202a, the present application is not limited thereto.

Next, as shown in step 202c, filtering the soaked raw material by a 60 mesh screen sieve 3 and flows it into the mixer 4.

On the other hand, the extraction solvent is pre-charged into the extraction tank 6 as shown in step 202d. The extraction solvent volume is ⅔-¾ of the extraction tank 6. The extraction solvent may be water or an ethanol solution.

Next, as shown in step 202e and FIG. 1, a nozzle is inserted 2-3 cm under a liquid surface of the extraction solvent. The high-pressure piston pump 5 sprays the soaked raw plant material into the extraction solvent. A speed of high-pressure spraying the soaked raw plant material is 500-1000 L/h. A pressure for high-pressure spraying the soaked raw plant material into the extraction solvent is 1.0-3.0 Mpa.

As shown in step 202f, a pump is driven to countercurrent spraying the extraction solvent from the solvent tank 12 to a bottom portion of the extraction tank 6. The extraction solvent is water or an ethanol solution, depending on different types of plants. The present application utilizes the ethanol solution as an example. A speed of countercurrent spraying the second extraction solvent is 200-600 L/h. The temperature inside the extraction tank 6 is room temperature.

The crude extract is discharge from the extraction tank 6 to the extract container 9. A speed of discharging the crude extract is 400-900 L/h.

Next, as shown, in step 203, concentrating the crude extract to form final extract. Specifically, the first step of the step 203 is heating the crude extract to at least 60° C. as shown in step 203a. Then, spraying the crude extract into the concentrator 13 as shown in step 203b. A vacuum degree inside the concentrator 13 is −0.9 Mpa.

During the process of dropping, the extraction solvent of the crude extract will be evaporated as shown in step 203c. Last, as shown in step 203d, transforming the evaporated solvent back to liquid form via the condenser 11. The final extract is stay in the concentrator 13.

Based on the above, the present application increases the contacting area between the solute and the solvent due to spraying technique. In addition, the solute diffusion is improved since the solvent is continuously countercurrent moving. Therefore, the rate of producing the final extract can be increased by 5-6 times, enhancing the extraction efficiency. Moreover, the solvent usage and consumption are greatly reduced, which in turn reduces the costs.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A method for extracting effective components from plant by high-pressure spraying process, comprising:
pulverizing the plant to form raw plant material;
atomized extracting the raw plant material to form crude extract, comprising:
soaking the raw plant material by soaking, solution;
high-pressure spraying the soaked raw plant material into an extraction solvent; and
extracting the soaked raw plant material to form the crude extract; and
concentrating the crude extract to form final extract.

2. The method for extracting effective components from plant by high-pressure spraying process as claimed in claim 1, wherein the step of pulverizing the plant to form raw plant material comprises pulverizing the plant by pulverizer with a built-in 80-120 mesh screen sieve.

3. The method for extracting effective components from plant by high-pressure spraying process as claimed in claim 1, wherein the soaking solution is water or an ethanol solution with 30%-98% of volume concentration.

4. The method for extracting effective components from plant by high-pressure spraying process as claimed in claim 3, wherein the soaking solution the ethanol solution with 30%-98% of volume concentration,

5. The method for extracting effective components from plant by high-pressure spraying process as claimed in claim 1, wherein the step of soaking the raw plant material by ethanol solution further comprises soaking the raw plant material for 1-2 hours.

6. The method for extracting effective components from plant by high-pressure spraying process as claimed in claim 1, wherein the step of soaking the raw plant material by ethanol solution further comprises, stirring the raw plant material.

7. The method for extracting effective components from plant by high-pressure spraying process as claimed in claim 5, wherein a stirring rate for stirring the raw plant material is 60-100 r/min.

8. The method for extracting effective components from plant by high-pressure spraying process as claimed in claim 1, wherein after soaking the raw plant material by the ethanol solution, the method further comprises filtering the soaked raw material.

9. The method for extracting effective components from plant by high-pressure spraying process as claimed in claim 7, wherein the soaked raw material is filtered by a 60 mesh screen sieve.

10. The method for extracting effective components from plant by high-pressure spraying process as claimed in claim 1, wherein a volumetric weight ratio between the soaking solution and the raw plant material is 6 L:1 kg.

11. The method for extracting effective components from plant by high-pressure spraying process as claimed in claim 1, wherein the step of atomized extracting thee raw plant material to form crude extract further comprises pre-charging the extraction solvent into a tank before high-pressure spraying the soaked raw plant material into the extraction solvent.,

12. The method for extracting effective components from plant by high-pressure spraying process as claimed in claim 11, wherein an extraction solvent volume is ⅔-¾ of the tank.

13. The method for extracting effective components from plant by high-pressure spraying process as claimed in claim 11, wherein the extraction solvent is water or an ethanol solution.

14. The method for extracting effective components from plant by high-pressure Spraying process as claimed in claim 13, wherein the extraction solvent the ethanol solution.

15. The method for extracting effective components from plant by high-pressure spraying process as claimed in claim 11, wherein a nozzle is inserted 2-3 cm under a liquid surface of the extraction solvent for high-pressure spraying.

16. The method for extracting effective components from plant by high-pressure spraying process as claimed in claim 11, wherein the step of atomized extracting the raw plant material to form crude extract further comprises countercurrent spraying the extraction solvent from a bottom portion of the tank.

17. The method for extracting effective components from plant by high-pressure spraying process as claimed in claim 16, wherein a speed of countercurrent spray the extraction solvent is 200-600 L/h.

18. The method for extracting effective components from plant by high-pressure spraying process as claimed in claim 1, wherein a speed of high-pressure spraying the soaked raw plant material is 500-1000 L/h.

19. The method for extracting effective components from plant by high-pressure spraying process as claimed in claim 1, wherein a pressure for high-pressure spraying, the soaked raw plant material into the extraction solvent is 1.0-3.0 Mpa.

20. The method for extracting effective components from plant by high-pressure spraying process as claimed in claim 1, wherein the step of concentrating the crude extract to form final extract comprises:
heating the crude extract to at least 60° C.;
spraying the crude extract into a concentrator, wherein a vacuum degree inside the concentrator is −0.9 Mpa; and
evaporating the extraction solvent of the crude extract to form the final extract.
